(19) United States
(12) Patent Application Publication
(10) Pub. No.: US 2019/0011911 A1
(43) Pub. Date: Jan. 10, 2019

(54) MOVING BODY REMOTE CONTROL SYSTEM AND MOVING BODY REMOTE CONTROL METHOD

(71) Applicant: HITACHI, LTD., Tokyo (JP)

(72) Inventors: Hiroyuki KUBO, Tokyo (JP); Hideki ENDO, Tokyo (JP); Shoji YUNOKI, Tokyo (JP)

(73) Assignee: HITACHI, LTD., Tokyo (JP)

(21) Appl. No.: 15/921,309

(22) Filed: Mar. 14, 2018

(30) Foreign Application Priority Data
Jul. 7, 2017 (JP) 2017-133509

(51) Int. Cl. G05D 1/00; G06T 7/20

(52) U.S. Cl. CPC G05D 1/0038; G05D 1/0088; G06T 11/60; G06T 7/20; G05D 2201/0213; G05D 1/0061

(57) ABSTRACT

Provided is a moving body remote control system retains path information of a path along which a moving body autonomously travels and camera information of a camera provided in the moving body; stores the position of the moving body and an acquisition time thereof; outputs, upon receiving an image taken by the camera and an imaging time of the image, data of the received image, and stores the imaging time; estimates the position and direction of the moving body at the imaging time; identifies a part of the path included in the range of the image based on the path information, the camera information, and the estimated position and direction of the moving body; and converts the coordinates of the identified part of the path into coordinates of the image and outputs data of the image on which the path is superposed, at the position of the converted coordinates.

### CLAIM OF PRIORITY

The present application claims priority from Japanese patent application JP2017-133509 filed on Jul. 7, 2017, the content of which is hereby incorporated by reference into this application.

### BACKGROUND OF THE INVENTION

The present invention relates to a technique to operate a moving body from a remote location.

An autonomously-traveling moving body such as an automatic-driving vehicle is generally configured so that a sensor provided on the vehicle body acquires the external environment information. Based on this information, a traveling path is autonomously determined based on a predetermined operation program to perform the autonomous traveling. If the external environment information is beyond what can be analyzed by the predetermined operation program, then the operation program is blocked, thus failing to continue the autonomous traveling.

In such an environment, a means to operate the moving body from a remote location to avoid a location at which the autonomous traveling is difficult and move the vehicle to a location where the autonomous traveling is possible so that the autonomous traveling can be recovered is effective.

This kind of prior art includes a method titled “remote control system” disclosed in JP 2010-61346 A (Patent Document 1). According to the method disclosed in Patent Document 1, a remote control system is used, in which a moving body includes an imaging unit for acquiring an image of a moving region. The system includes a display unit for displaying the image acquired by the imaging unit and a remote control apparatus for remotely controlling the moving body based on the displayed image. The communication delay time between the moving body and the remote control apparatus is estimated to calculate a proposed moving path of the moving body at a necessary time after the image acquisition time. Then, the calculated path is superposed on the image displayed on the display unit.

### SUMMARY OF THE INVENTION

If the moving body is currently able to travel autonomously, the remote control should allow the moving body to return to a state in which the autonomous traveling is possible. However, in the case of the system disclosed in Patent Publication 1, the system does not provide a support in which the moving body is allowed to return to the autonomous traveling. Patent Publication 1 discloses a means to allow, in a situation where the moving body and the remote control apparatus have a lengthy communication delay therebetween during the remote control, a subject controlling the remote control apparatus to operate the moving body in a more intuitive manner.

If a region in which the autonomous traveling can be performed is determined in advance, the region may be correctly superposed on a display screen during the remote control. This allows an operator to remotely control the moving body toward the region, thus achieving the remote control more easily.

In order to display, on a screen, position-based information such as the one for a region so that the information is superposed on the screen, it is necessary to correctly know the position, direction, and photographing angle, for example, of the imaging apparatus. Based on the resultant values, the information must be subjected to a coordinate conversion. The imaging apparatus in the moving body has different positions and directions with time during the remote control. Thus, the information of the imaging time is particularly important. Generally, the imaging apparatus and a sensor for acquiring the position information are separate components having different operation cycles and processing times. Thus, when the information subjected to the coordinate conversion based on the latest position information is displayed on the latest image retained by the remote control apparatus in a superposed manner, an undesirable gap occurs among regions on the screen, thus failing to provide sufficient supplementary information to perform the remote control.

In order to solve the foregoing problems, the present invention provides a moving body remote control system having a processor, an interface unit that is coupled to the processor and that communicates with the moving body, a storage unit coupled to the processor, and a display unit coupled to the processor, wherein: the storage unit retains path information showing the position of a path along which the moving body autonomously travels and camera information including the position, direction, and angle of view of a camera provided in the moving body; and the processor is configured: to store, upon receiving the position of the moving body and the acquisition time of the position via the interface unit, the received position and acquisition time in the storage unit; to output, upon receiving an image taken by the camera and an imaging time at which the image was taken via the interface unit, data of the received image to the display unit and store the imaging time in the storage unit; to estimate, based on the imaging time and the position of the moving body at the acquisition time, the position and direction of the moving body at the imaging time; to identify a part of the path included in the range of the image based on the path information, the camera information, and the estimated position and direction of the moving body; and to convert, based on the path information, the camera information, and the estimated position and direction of the moving body, the coordinates of the identified part of the path into coordinates of the image and output, to the display unit, data of the image on which the path is superposed, at the position of the converted coordinates.

According to an embodiment of the present invention, a region, which is a destination of the remote control, is displayed during the remote control of the moving body. Thus, the moving body can be easily moved by the operator performing the remote control. Problems, configurations, and effects other than the above-described ones will be made clear through the following description of embodiments.

### BRIEF DESCRIPTION OF THE DRAWINGS

FIG. 1A and FIG. 1B are schematic views illustrating a specific example of a display in which a region within which a moving body can be returned to autonomous traveling is displayed while being superposed on a display screen during the remote control.

FIG. 2A to FIG. 2F illustrate the relationship between the position of the moving body, a taken image and an autonomous traveling path superposed thereon.

FIG. 3 is a block diagram illustrating the configuration of the entire moving body remote control system of the embodiment of the present invention.

FIG. 4A and FIG. 4B are flowcharts illustrating an entire processing carried out by a moving body and a remote support center of the embodiment of the present invention.

FIG. 5 is a schematic view illustrating a specific example of the moving body information stored in a moving body information storage unit of the embodiment of the present invention.

FIG. 6 is a schematic view illustrating a specific example of path information stored in an autonomous traveling path storage unit of the embodiment of the present invention.

FIG. 7 is a schematic view illustrating a specific example of image information stored in an image information storage unit of the embodiment of the present invention.

FIG. 8 is a flowchart illustrating one method of estimating position information by a position estimation program of the embodiment of the present invention.

FIG. 9 is a schematic view illustrating a specific example of the processing of allowing the position estimation program of the embodiment of the present invention to estimate the position information based on the information stored in the moving body information storage unit.

FIG. 10 is a schematic view illustrating a specific example of the processing of allowing an autonomous traveling path display program of the embodiment of the present invention to narrow down the information for a region to be subjected to the coordinate conversion.

FIG. 11A to FIG. 11C are schematic views illustrating an example of the principle of operation of the coordinate conversion by the autonomous traveling path display program of the embodiment of the present invention.

FIG. 12A to FIG. 12D are schematic views illustrating an example of the autonomous traveling path superposed on the screen in the embodiment of the present invention.

FIG. 13 is a schematic view illustrating a specific example of the information superposed on the screen in the embodiment of the present invention.

### DETAILED DESCRIPTION OF EMBODIMENTS

First, the following section will describe the influence of a difference between the time at which an image displayed during the remote control is imaged and the time at which the position information is acquired.

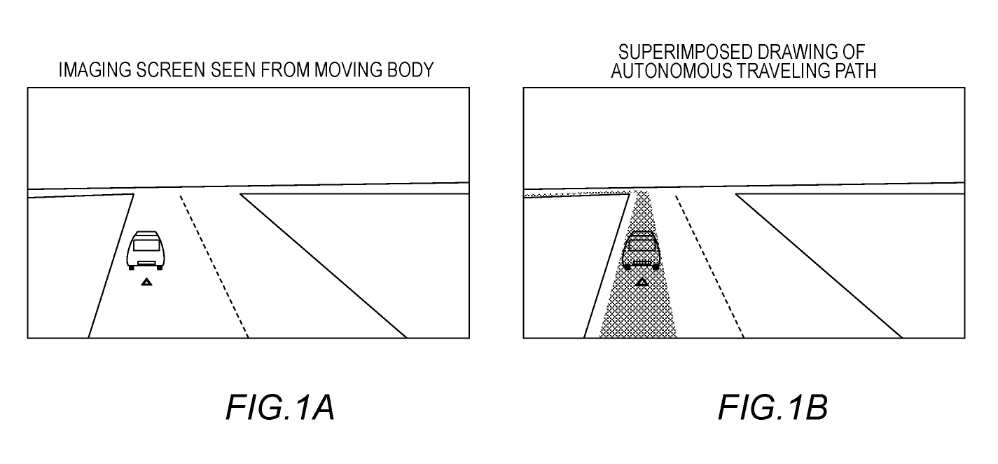

FIG. 1A and FIG. 1B are schematic views illustrating a specific example of a display in which a region within which the moving body can be returned to the autonomous traveling is displayed while being superposed on the display screen during the remote control.

FIG. 1A illustrates an example of an image of the front side photographed by the moving body (an autonomously-traveling vehicle in this example) while the moving body is traveling. In this example, on a path along which the moving body is planned to travel by the autonomous traveling, another vehicle is stopped due to a failure. Since the moving body does not have an operation program to avoid this, the autonomous traveling is undesirably canceled (FIG. 1A). In a situation where the autonomous traveling path is determined in advance, the moving body can be returned to the autonomous traveling by avoiding the stopped vehicle and by remotely controlling the moving body to a region on the autonomous traveling path on which no other obstacles exist in front of the moving body. Thus, in the above situation, the predetermined autonomous traveling path is desirably displayed on the display screen during the remote control in a superposed manner, as shown in FIG. 1B.

In order to allow position-based information to be superposed on an image acquired by an imaging apparatus such as a camera provided in the moving body, the accuracy of the position of the moving body is important.

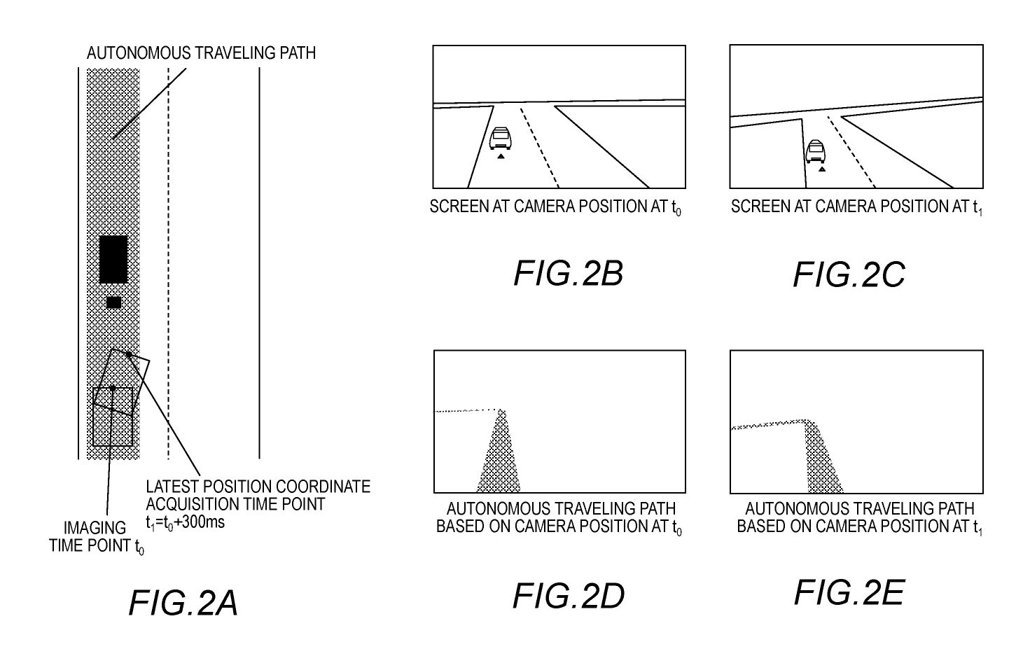

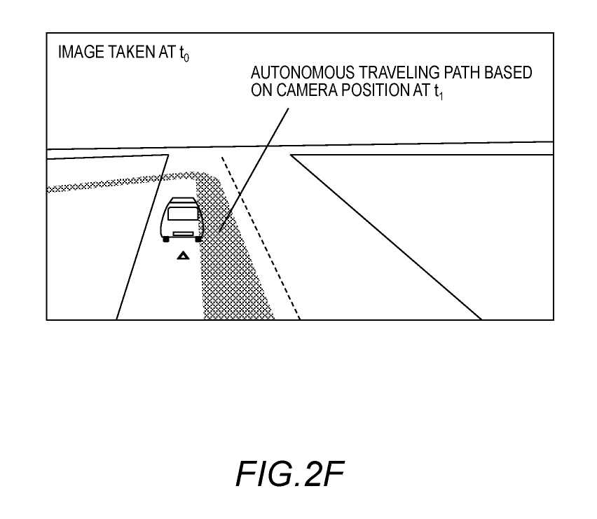

FIG. 2A to FIG. 2F illustrate the relationship between the position of the moving body, the taken image and the autonomous traveling path superposed thereon.

The camera image is generally subjected to a processing such as encoding and is subsequently transmitted from the moving body to the remote control apparatus. In this case, the screen drawn on the display screen during the remote control is delayed compared to the actual situation by an amount of the communication delay and the processing delay for the encoding, for example. On the other hand, the sensor for acquiring the position information is generally a component operating with a cycle different from that of the camera. The information from the sensor transmitted to the remote control apparatus is delayed by the communication delay from the time point at which the position information was acquired. Thus, when the camera image and the position information are transmitted continuously, the respective pieces of the latest information therefrom are received by the remote control apparatus at acquisition times undesirably delayed from each other. In the example of FIG. 2A to FIG. 2F, it is assumed that the latest camera image taken at the time t0 was received at a certain time by the remote control apparatus and the position information was acquired at t₁=t₀+300 ms. In this case, the moving body was moved forward and rotated by the remote control in proportion to 300 ms (FIG. 2A). FIG. 2B and FIG. 2C illustrate the examples of the camera images taken at the camera positions at to and ti, respectively. FIG. 2D and FIG. 2E illustrate the examples of the autonomous traveling path subjected to coordinate conversion based on the camera positions at t₀ and t₁, respectively. In this case, when the autonomous traveling path subjected to the coordinate conversion based on the position information at t₁ is superposed on the camera image imaged at t₀, a difference in the camera position and the imaging angle used as a reference of the coordinate conversion prevents the autonomous traveling path from being correctly superposed on the camera image, as shown in FIG. 2F.

In the present invention, a place where the remote control apparatus is provided will be referred to as a remote support center. The remote support center includes therein an operating personnel always available to perform the remote control of the moving body. When the autonomously-traveling moving body finds it no longer possible to continue the autonomous traveling, the operating personnel remotely controls the moving body using a display and a controller provided in the remote support center.

The following section will describe an embodiment of the present invention with reference to the drawings.

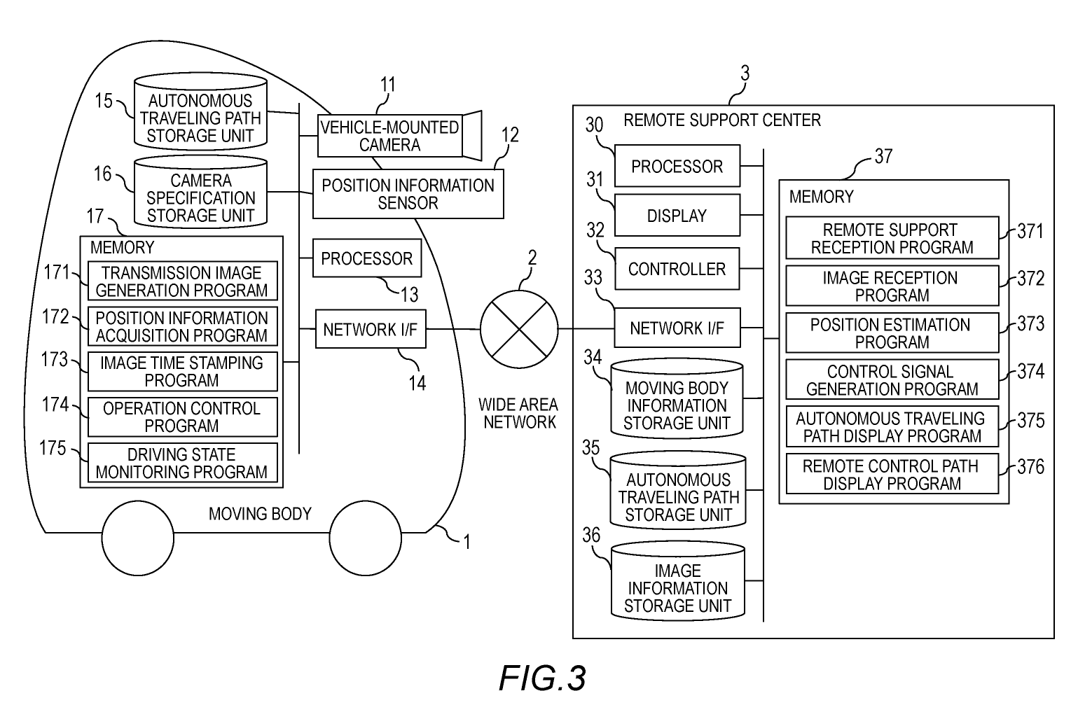

FIG. 3 is a block diagram illustrating the configuration of the entire moving body remote control system of the embodiment of the present invention.

The moving body remote control system of this embodiment is composed of a moving body 1 that can have communication via a wide area network 2, and a remote support center 3 for remotely controlling this.

The moving body 1 includes a vehicle-mounted camera 11, a position information sensor 12, a processor 13, a network I/F 14 communicating with the remote support center 3 via the wide area network 2, an autonomous traveling path storage unit 15, a camera specification storage unit 16, and a memory 17 for retaining a plurality of programs. The moving body 1 retains a sensor, for example (not shown), for retaining the external environment required to perform the autonomous traveling. In this embodiment, a vehicle autonomously traveling on a road is shown as an example of the moving body 1. However, the present invention is not limited to vehicles and can be applied to any type of moving body.

In the example of FIG. 3, the memory 17 retains a transmission image generation program 171, a position information acquisition program 172, an image time-stamping program 173, an operation control program 174, and a driving state monitoring program 175. The processor 13 realizes various functions of the moving body 1 by executing programs retained in the memory 17. In the following description, the processing described so that the program in the memory 17 is actually executed by the processor 13 based on an instruction described in the program in the memory 17 while optionally controlling the respective parts of the moving body 1.

Depending on the request from the transmission image generation program 171, the vehicle-mounted camera 11 transmits a taken image to the transmission image generation program 171. The taken image may be a collection of continuous images as in streaming video. An interval at which an image is taken to generate the streaming video may be changed by the settings of the transmission image generation program 171.

The position information sensor 12 is a sensor providing a function to acquire position coordinates (e.g., GPS (Global Positioning System)). The position information sensor 12 sequentially acquires, depending on the request from the position information acquisition program 172, position coordinates at a fixed time interval and transmit the position coordinates to the position information acquisition program 172. The interval at which the position information is acquired may be changed by the settings of the position information acquisition program 172.

The autonomous traveling path storage unit 15 is a database to store a path used during the autonomous traveling. The autonomous traveling path storage unit 15 acquires the autonomous traveling path from the remote support center 3 to retain the path information thereof.

The camera specification storage unit 16 is a database to store the specification information of the vehicle-mounted camera 11. The camera specification includes all information of the vehicle-mounted camera 11 required to perform the coordinate conversion (e.g., the position of the vehicle-mounted camera 11 (e.g., the set height), the angle of view and the direction (e.g., a horizontal angle that is an angle formed by the horizontal plane and the camera photographing direction) (i.e., an angle formed by the horizontal plane and the camera photographing direction)).

The autonomous traveling path storage unit 15 and the camera specification storage unit 16 may be stored in a storage apparatus such as a hard disk drive in the moving body 1 or a storage apparatus such as a flash memory, or at least a part thereof may be optionally retained by the memory 17.

The transmission image generation program 171 is one of the programs stored in the memory 17 and acquires images from the vehicle-mounted camera 11 to allocate IDs to the individual images to transmit the images to the remote support center 3 via the network I/F 14.

The image time-stamping program 173 is one of the programs stored in the memory 17 and sets the time at which the image was taken by the vehicle-mounted camera 11 to associate the time with the ID allocated by the transmission image generation program 171 to transmit the resultant information as image information to the remote support center 3 via the network I/F 14.

The transmission image generation program 171 and the image time-stamping program 173 may be a single program. If the vehicle-mounted camera 11 includes functions of a memory and a processor, for example, the above two programs may be a program stored in the memory of the vehicle-mounted camera 11. This embodiment does not limit components providing the functions of both programs described above.

The position information acquisition program 172 is one of the programs stored in the memory 17 and acquires the position information from the position information sensor 12 to transmit the acquisition information and the acquisition time to the remote support center 3 via the network I/F 14.

The operation control program 174 is one of the programs stored in the memory 17 and provides a function to control the moving body 1 based on information acquired from an external environment sensor (not shown) retained by the moving body 1 and the autonomous traveling path stored in the autonomous traveling path storage unit 15 to thereby realize the autonomous traveling. The operation control program 174 provides a function to control the moving body 1 based on the control signal received from the remote support center 3 to thereby realize the remote control.

The driving state monitoring program 175 is one of the programs stored in the memory 17 that continuously determines whether or not the moving body 1 can travel autonomously. When it is determined that the moving body 1 can no longer travel autonomously, the driving state monitoring program 175 notifies the remote support center 3 of the information via the network I/F 14 to request the remote control.

The remote support center 3 has a processor 30, a display 31 for displaying an image received from the moving body 1, a controller 32 for allowing an operator to remotely control the moving body 1, a network I/F 33 communicating with the moving body 1 via the wide area network 2, a moving body information storage unit 34, an autonomous traveling path storage unit 35, an image information storage unit 36, and a memory 37 for retaining a plurality of programs.

In the example of FIG. 3, the memory 37 retains a remote support reception program 371, an image reception program 372, a position estimation program 373, a control signal generation program 374, an autonomous traveling path display program 375, and a remote control path display program 376. The processor 30 realizes various functions of the remote support center 3 by executing the programs retained in the memory 37. In the following description, the processing described in a way that may suggest that it is executed by a program in the memory 37 is actually executed by allowing the processor 30 to control the respective parts of the remote support center 3 as required based on instructions described in each program in the memory 37. The communication between the moving body 1 and the remote support center 3 is performed via the network I/F 14, the wide area network 2, and the network I/F 33.

The moving body information storage unit 34, the autonomous traveling path storage unit 35, and the image information storage unit 36 may be stored in a hard disk drive in the remote support center 3 or a storage apparatus such as a flash memory, for example, or at least a part thereof may be retained in the memory 37.

The controller 32 is an input apparatus that is operated by an operator when the remote support center 3 is remotely controlling the moving body 1. For example, the controller 32 may have a steering wheel, an accelerator pedal, and a brake pedal, operated by the operator to allow the control signal generation program 374 to generate a control signal depending on the operation amount thereof to thereby send the control signal to the moving body 1.

FIG. 3 illustrates only one moving body 1. However, a plurality of moving bodies 1 can be actually controlled by the remote support center 3.

The moving body information storage unit 34 is a database that stores therein the information for the moving body 1 controlled by the remote support center 3.

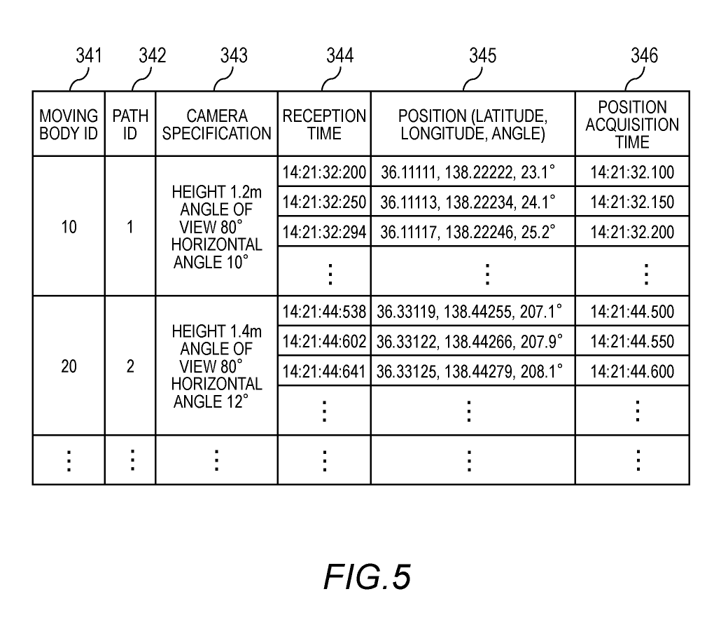

FIG. 5 is a schematic view illustrating a specific example of the moving body information stored in the moving body information storage unit 34 of the embodiment of the present invention.

The moving body information includes an ID 341 for identifying the moving body 1, an ID 342 of the autonomous traveling path currently retained by the moving body 1, the camera specification 343 of the moving body 1, position information 345 sequentially transmitted from the moving body, the time 346 at which the position information was acquired by the moving body 1, and the time 244 at which the position information was received by the remote support center 3. The position information 345 includes the information showing the latitude and longitude of the moving body 1 acquired at the time shown by the time 344 and a direction in which the moving body 1 is heading, for example.

The moving body information may also further include, in addition to the above information, specific information regarding each moving body 1. For example, the moving body information may include information regarding the size such as the vehicle width of each moving body 1 or shape-related information.

The autonomous traveling path storage unit 35 is a database that retains a path along which the moving body 1 controlled by the remote support center 3 is able to travel autonomously.

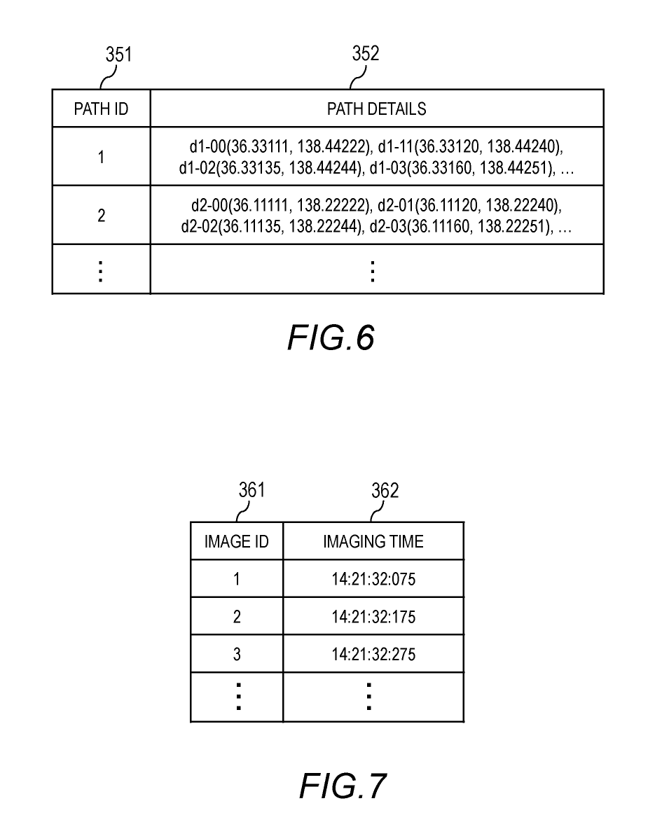

FIG. 6 is a schematic view illustrating a specific example of the path information stored in the autonomous traveling path storage unit 35 of the embodiment of the present invention.

In this embodiment, the term “path” is a path generated as a path along which the moving body moves according to general automatic driving techniques, for example. Specifically, the path of this embodiment intends to mean a collection of coordinate values representing a route in a space along which the moving body 1 actually moves, for example. This collection is retained by the remote support center 3 and the moving body 1. This path does not require a structure in an actual space to guide the moving body 1 (e.g., a rail, a signal transmission apparatus for guiding the moving body 1, or a line drawn on an actual road to display the course of the moving body 1).

The autonomous traveling path storage unit 35 illustrated in FIG. 6 retains a path ID 351 for identifying each autonomous traveling path and the path details 352 showing the details of each autonomous traveling path. The autonomous traveling path is represented by a collection of coordinate points d as shown in the path details 352, for example. In the present invention, it is assumed that the autonomous traveling of the moving body is performed along a predetermined path. However, this does not limit how the basic information for performing the autonomous traveling is provided. Specifically, the autonomous traveling path may be retained as point group information as shown in the path details 352 or may be retained as diagrammatic information such as a line. The remote support center 3 retains the autonomous traveling paths of all moving bodies 1 controlled by the remote support center 3. The respective autonomous traveling paths are allocated with the path IDs 351 and are controlled as a database.

The image information storage unit 36 is a database that retains the time at which an image received by the remote support center 3 from the moving body 1 was taken.

FIG. 7 is a schematic view illustrating a specific example of the image information stored in the image information storage unit 36 of the embodiment of the present invention.

The image information storage unit 36 retains the image ID 361 for identifying an image transmitted from the image time-stamping program 173 and the imaging time 362 showing the time at which the image was taken.

The remote support reception program 371 is one of the programs stored in the memory 37 and provides a function to accept a request for the moving body 1 to start the remote control processing.

The image reception program 372 is one of the programs stored in the memory 37 and outputs the image information received from the moving body 1 to the display 31 to allow the image to be displayed thereon.

The position estimation program 373 is one of the programs stored in the memory 37 and provides a function to refer to the moving body information storage unit 34 and the image information storage unit 36 to estimate the position information of the moving body 1 at the imaging time of the image displayed on the display 31.

The control signal generation program 374 is one of the programs stored in the memory 37 and provides a function to generate a signal for controlling the moving body based on an operation value obtained by allowing the operator to use and operate the controller 32 to transmit the signal to the moving body 1 via the network I/F 33.

The autonomous traveling path display program 375 provides a function to perform, based on the position information estimated by the position estimation program 373 and the vehicle-mounted camera specification 343 retained by the moving body information storage unit 34, a coordinate conversion on the autonomous traveling path retained by the autonomous traveling path storage unit 35 to display the resultant path on the display in a superposed manner.

The remote control path display program 376 provides a function to calculate and coordinate-convert, based on the position information estimated by the position estimation program 373 and the operation value of the controller 32, the path obtained through the remote control along which the moving body travels and display the path on the display in a superposed manner.

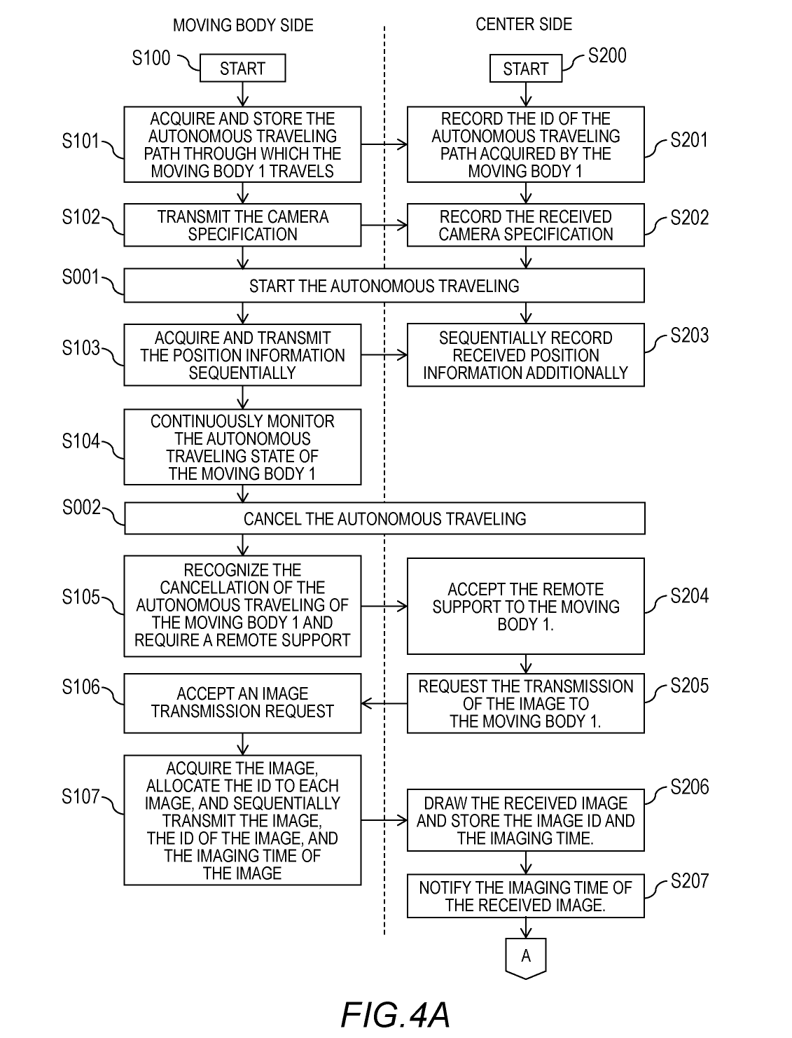

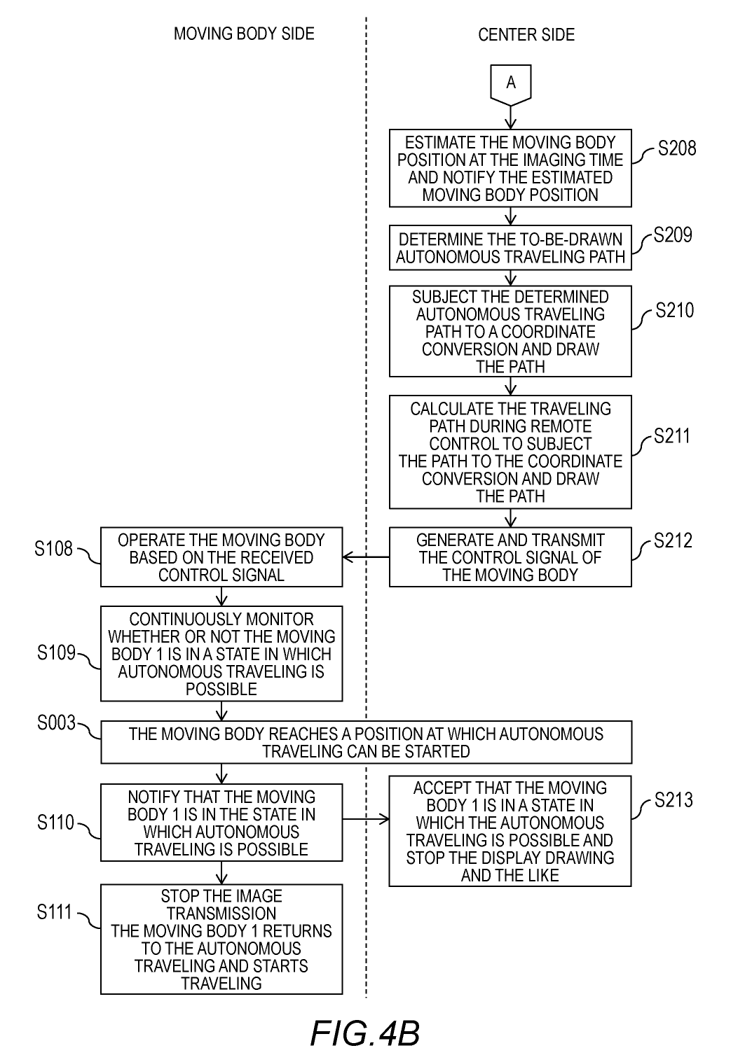

FIG. 4A and FIG. 4B are flowcharts illustrating the entire processing carried out by the moving body 1 and the remote support center 3 of the embodiment of the present invention. The following section will describe the operation of this embodiment based on the flowcharts.

Prior to the start of the autonomous traveling, the moving body 1 acquires the autonomous traveling path along which the moving body 1 should travel from the autonomous traveling path storage unit 35 of the remote support center 3 to store the path in the autonomous traveling path storage unit 15 of the moving body 1 (S101).

The remote support center 3 records, in the moving body information storage unit 34, the ID of the autonomous traveling path acquired by the moving body 1 (S201).

Prior to the start of the autonomous traveling, the moving body 1 transmits the camera specification information stored in the camera specification storage unit 16 to the remote support center 3 (S102).

After receiving the camera specification information, the remote support center 3 records the camera specification information in the camera specification 343 of the moving body information storage unit 34 (S202).

Based on the acquired autonomous traveling path, the moving body 1 performs the autonomous traveling (S001).

During the travel, the position information acquisition program 172 of the moving body 1 sequentially acquires the position information from the position information sensor 12 to sequentially transmit the position information to the remote support center 3 (S103). This processing is performed in any state such as the autonomous traveling or the remote control. However, the position information may be acquired at a different interval depending on the autonomous traveling or the remote control. Then, the position information acquisition program 172 acquires the current traveling state from the driving state monitoring program 175 to change, based on the traveling state, the settings of the position information sensor 12 such as an interval at which the position information is acquired.

The remote support center 3 sequentially records the received position information in the moving body information storage unit 34 (S203).

The position information transmitted in S103 includes at least the coordinate value showing the position of the moving body 1 and the time at which the coordinate value was acquired. This position information may also further include information showing the direction of the moving body 1 (e.g., the azimuth angle of the direction along which the moving body 1 travels). When the position information includes the azimuth angle, the azimuth angle is stored as the angle of the position 345. The position information acquisition program 172 of the moving body 1 may estimate the direction of the moving body 1 at each time based on the position of the moving body 1 at each time. Alternatively, when the moving body 1 has an electromagnetic compass or a gyro sensor, for example, the direction of the moving body 1 may be acquired based on the output thereof and may be transmitted in S103. When the position information transmitted in S103 does not include the information showing the direction of the moving body 1, the remote support center 3 may estimate the direction of the moving body 1 at each time based on the position of the moving body 1 at each time included in the received position information and store the result as the angle of the position 345.

The driving state monitoring program 175 of the moving body 1 sequentially monitors the autonomous traveling state of the moving body 1 (S104).

When the moving body 1 can no longer continue the autonomous traveling due to the existence of a collision-damaged vehicle on the autonomous traveling path, for example, then the moving body 1 cancels the autonomous traveling (S002).

When the driving state monitoring program 175 of the moving body 1 monitoring the autonomous traveling state of the moving body 1 senses the cancellation of the autonomous traveling, then the driving state monitoring program 175 makes a request for remote support to the remote support center 3 (S105). The remote support reception program 371 of the remote support center 3 accepts the remote support request from the moving body 1 (S204).

The remote support reception program 371 of the remote support center 3 requests the moving body 1 to transmit the image (S205). The transmission image generation program 171 of the moving body 1 accepts the image transmission request (S106).

The transmission image generation program 171 of the moving body 1 acquires the image from the vehicle-mounted camera 11, allocates the ID to the image and transmits the resultant image to the remote support center 3. The image time-stamping program 173 acquires the imaging time of the image and transmits the image ID and the imaging time as image information to the remote support center 3 (S107).

After receiving the image from the moving body 1, the image reception program 372 outputs the image to the display 31 to draw the image thereon. The image information (i.e., the image ID and the imaging time) received from the moving body 1 is stored in the image information storage unit 36 (S206). The image reception program 372 may also store the image received from the moving body 1 at least temporarily in the image information storage unit 36 or the memory 37.

The image reception program 372 of the remote support center 3 inquires the image information storage unit 36 and acquires the imaging time of the received image (i.e., the currently-drawn image) to notify the imaging time to the position estimation program 373 (S207).

The position estimation program 373 of the remote support center 3 estimates the position of the moving body 1 at the imaging time based on the notified imaging time and the position information of the moving body 1 accumulated in the moving body information storage unit 34. Then, the position estimation program 373 notifies the autonomous traveling path display program 375 of the estimated moving body position (S208).

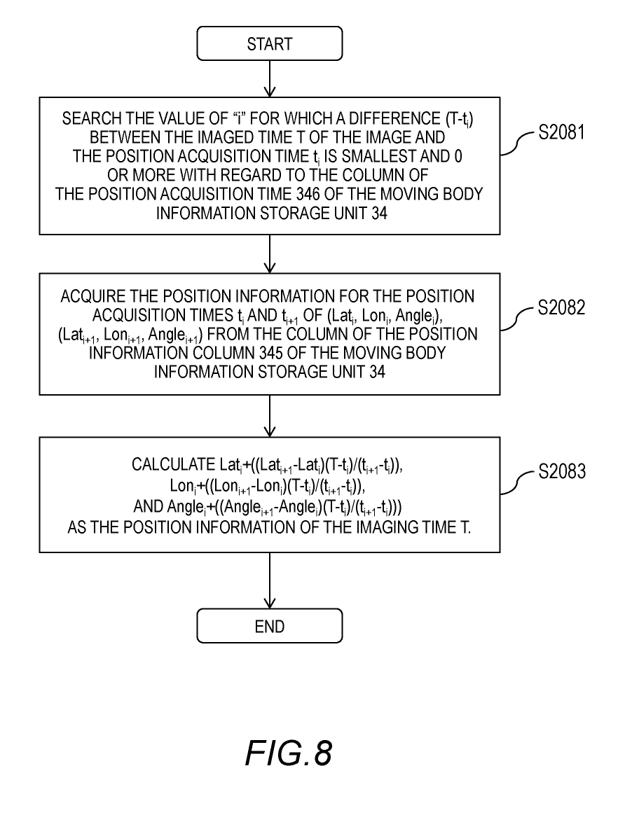

FIG. 8 is a flowchart illustrating one method of estimating the position information by the position estimation program 373 of the embodiment of the present invention.

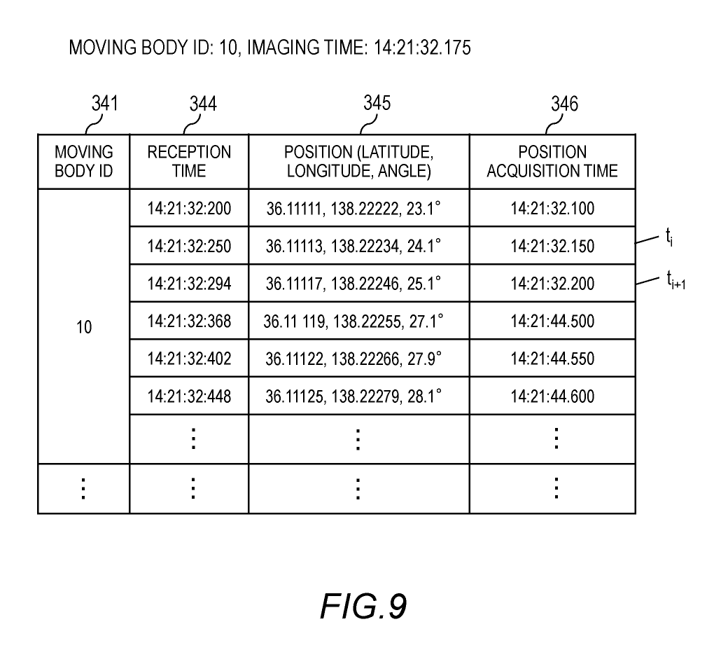

FIG. 9 is a schematic view illustrating a specific example of the processing of allowing the position estimation program 373 of the embodiment of the present invention to estimate the position information based on the information stored in the moving body information storage unit 34.

The following section will describe one position information estimate method with reference to FIG. 8 and FIG. 9.

The position estimation program 373 searches the column 346 of the position acquisition time of the moving body 1 (i.e., the moving body 1 that is a remote support target and that has transmitted the currently-drawn image) of the information stored in the moving body information storage unit 34 to find the line number I of the line that includes a value at which the difference T−tᵢ between the image imaging time T and the position information acquisition time tᵢ is minimum and 0 or more (S2081) where tᵢ≤t₊₁ is established.

The position estimation program 373 acquires the position information acquisition time tᵢ, the tᵢ₊₁ position information, (Latᵢ, Lonᵢ, Angleᵢ), and (Latᵢ₊₁, Lonᵢ₊₁, Angleᵢ₊₁) from the column 345 of the position information column of the moving body 1 of the moving body information storage unit 34 (S2082). The symbol “Latᵢ” shows a latitude stored in the ith line of the moving body information storage unit 34, the symbol “Lonᵢ” shows the longitude stored in the ith line of the moving body information storage unit 34, and the symbol “Angleᵢ” shows the moving body angle stored in the ith line of the moving body information storage unit 34.

In the example of FIG. 9, the imaging time T=14:21:32.175, tᵢ=14:21:32.150, and tᵢ₊₁=14:21:32.200 are established.

The position estimation program 373 calculates the position information of the imaging time T based on (Latᵢ, Lonᵢ, Angleᵢ) and (Latᵢ₊₁, Lonᵢ₊₁, Angleᵢ₊₁) (S2083). For example, the position information of the imaging time T is calculated as (Latᵢ+((Latᵢ₊₁−Latᵢ)(T−tᵢ)/(tᵢ₊₁−tᵢ)), Lonᵢ+((Lonᵢ₊₁−Lonᵢ(T−tᵢ)/(tᵢ₊₁−tᵢ)), and Angleᵢ+((Angleᵢ₊₁−Angleᵢ)(T−tᵢ)/(tᵢ₊₁−tᵢ))), for example.

In the present invention, it is assumed that the position estimation program 373 inquires the imaging time T and the moving body information storage unit 34 to estimate the position information. The above method is an example of a specific estimation method. Specifically, according to the above method, the positions and the directions of the moving body 1 at t₁ and tᵢ₊₁ before and after the photographing time T are acquired. Then, the ratio of the length from tᵢ to T to the length from tᵢ to tᵢ₊₁ i is multiplied with the position difference of the moving body 1 from tᵢ to tᵢ₊₁ to add the resultant value to the position of the moving body 1 at “t” to thereby estimate the position of the moving body 1 at the photographing time T. Similarly, the ratio of the length from tᵢ to T to the length from tᵢ to tᵢ₊₁ is multiplied with the direction difference of the moving body 1 between tᵢ and tᵢ₊₁, the resultant value is added to the direction of the moving body 1 at t, and the direction of the moving body 1 at the photographing time T is thereby estimated. This can consequently determine the position and direction of the moving body 1 at the photographing time T with sufficient accuracy.

However, this invention is not limited to the above example of the specific method of estimating the position information. For example, the position estimation program 373 may calculate the tᵢ closest to the imaging time T to use the position information (Latᵢ, Lonᵢ, Angleᵢ) as the estimation result. The position information acquired with a sufficiently short interval can provide the estimate of the position information by this method with a small amount of calculation and sufficient accuracy. Alternatively, the position estimation program 373 may also use the average value of (Latᵢ, Lonᵢ, Angleᵢ) and (Latᵢ₊₁, Lonᵢ₊₁, Angleᵢ₊₁) as the estimation result or may approximately calculate the curvature of the rotation of the moving body 1 based on a change in the position information of the imaging time T stored in the moving body information storage unit 34. Based on the rotation, the position information at the imaging time T may be calculated. These methods can also estimate the position and direction of the moving body 1 at the imaging time T with sufficient accuracy.

The autonomous traveling path display program 375 of the remote support center 3 refers to the autonomous traveling path ID retained by the moving body 1 stored in the moving body information storage unit 34 to acquire the autonomous traveling path information retained by the moving body 1 from the autonomous traveling path storage unit 35. The autonomous traveling path display program 375 determines, based on the acquired autonomous traveling path information and the position at the imaging time of the moving body 1 notified from the position estimation program 373 in S208, a region of the autonomous traveling path information as a target to be subjected to the coordinate conversion for the superposed display on the screen (S209). Based on the position of the moving body 1 and the camera specification stored in the moving body information storage unit 34, a region of the autonomous traveling path information to be subjected to the coordinate conversion for the superposed display on the screen is determined.

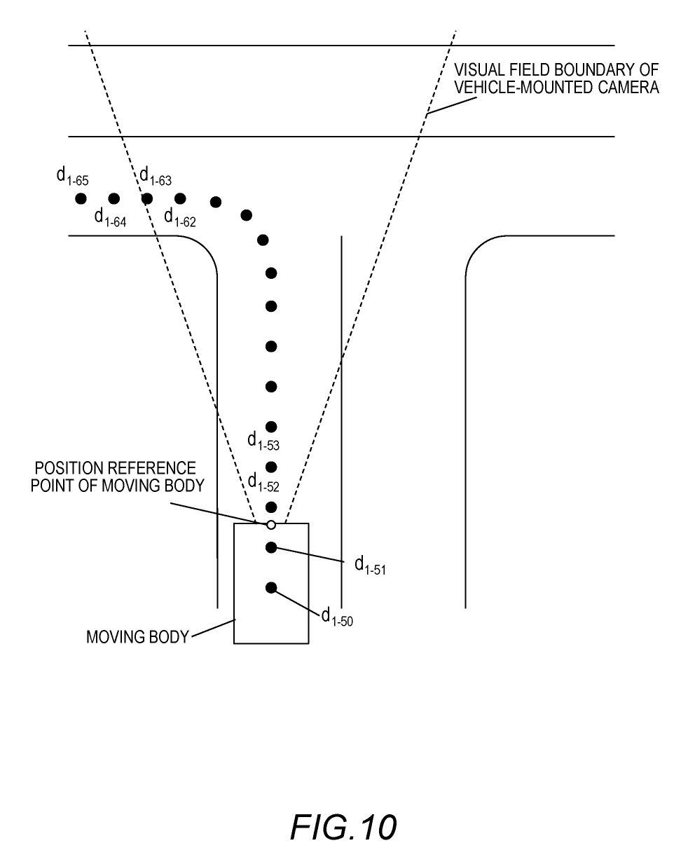

FIG. 10 is a schematic view illustrating a specific example of the processing of allowing the autonomous traveling path display program 375 of the embodiment of the present invention to narrow down the information for a region to be subjected to the coordinate conversion.

In the bird's-eye view of FIG. 10, the dotted line shows the visual field boundary of the vehicle-mounted camera 11. When the autonomous traveling path information is the point group information including the dots d₁₋₅₀ to the dots d₁₋₆₅, for example, the dots d₁₋₅₂ to the dots d₁₋₆₃ positioned at the front side of the vehicle-mounted camera and at the inner side of the visual field boundary of the vehicle-mounted camera represent a part within the image and thus are selected as a target to be subjected to the coordinate conversion for the superposed display on the screen.

The autonomous traveling path display program 375 of the remote support center 3 is configured to convert, based on the camera specification recorded in the moving body information storage unit 34 and the moving body position estimated in S208, the region of the autonomous traveling path determined in S209, the three-dimensional coordinate in the space in which the moving body 1 actually travels to the two-dimensional coordinate on the screen displayed by the display 31 of the remote support center 3. The information of the image obtained by superposing the autonomous traveling path on the converted coordinate is outputted to the display 31 to draw the image thereon (S210).

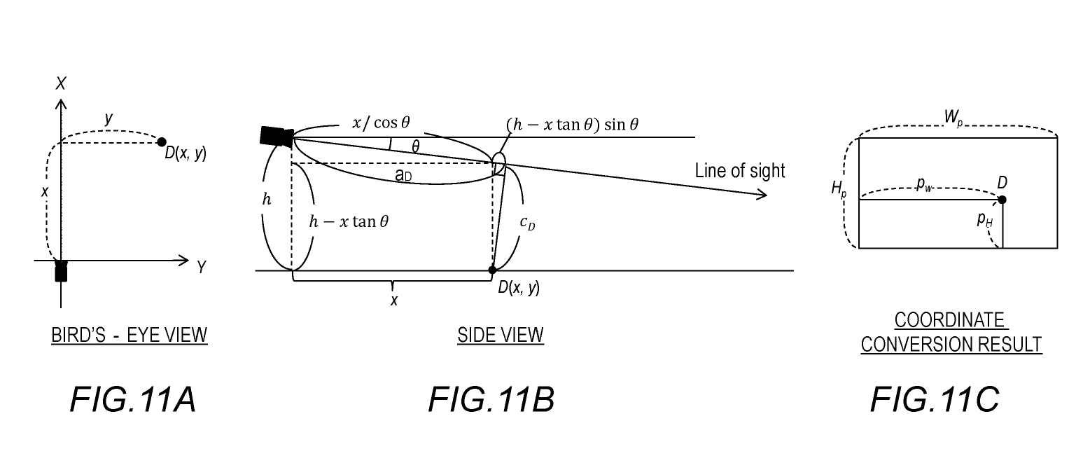

FIG. 11A to FIG. 11C are schematic views illustrating an example of the principle of operation of the coordinate conversion by the autonomous traveling path display program 375 of the embodiment of the present invention.

The coordinate conversion is performed based on the coordinates of the dots in the two-dimensional plane having the center of the lens of the vehicle-mounted camera 11 as an origin in the bird's-eye view (FIG. 11A) and the distance from the visual line of the vehicle-mounted camera in the side view (FIG. 11B) by calculating where the coordinate is displayed on the screen represented by pixels. The center of the lens of the vehicle-mounted camera 11 is determined based on the position of the moving body estimated in S208.

For example, in the bird's-eye view, the coordinate D(x, y) having the coordinate (x, y) in the quadratic plane having the origin at the center of the lens is drawn as the pixel coordinate (p_{W}, p_{H}) obtained in the screen having the pixel size (Wₚ, Hₚ) by the following formula when assuming that the camera's horizontal direction angle is 0, the camera's height is h, and the camera's angle of view is β (FIG. 11C).

p_{W}=(Wₚ/2)+((Wₚ/2)×y/((x/cos θ)+((h−(x−tan θ0))/sin θ)×tan β)

p_{H}=(Hₚ/2)+((Wₚ/2)×(h−(x×tan θ))×cos θ/((x/cos θ)+((h−x·tan θ)/sin θ)×tan β)

In the present invention, the calculation formula for the coordinate conversion is not limited to the above calculation formulas. Any calculation formula may be used so long as the formula can calculate the position to be displayed on the screen based on the specification of the vehicle-mounted camera and the coordinate position.

When the autonomous traveling path subjected to the coordinate conversion for the superposed display is a point group, then the autonomous traveling path may be subjected to the coordinate conversion and a straight line connecting the resultant point group may be represented as the autonomous traveling path. Alternatively, the autonomous traveling path may also be represented as a band having a fixed width such as the width of the moving body 1.

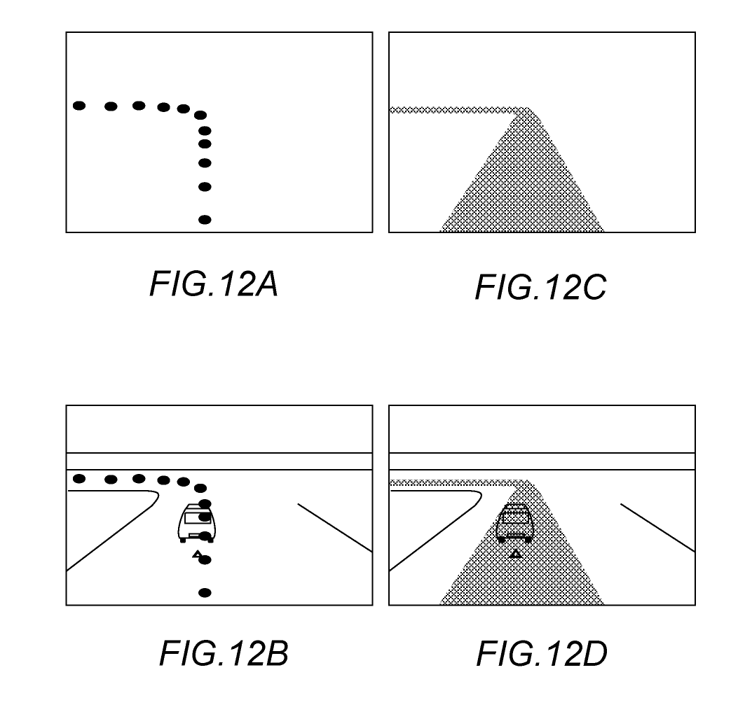

FIG. 12A to FIG. 12D are schematic views illustrating an example of the autonomous traveling path superposed on the screen in the embodiment of the present invention.

FIG. 12A illustrates an example of the point group subjected to the coordinate conversion. FIG. 12B illustrates an example of the point group superposed on an taken image. FIG. 12C, on the other hand, illustrates an example of the point group subjected to the coordinate conversion that is represented as a band. FIG. 12D illustrates an example of the band superposed on the taken image. The display as described above allows the operator of the controller 32 to understand the position of the autonomous traveling path more easily.

As described above, the width of the displayed band may be obtained by converting the vehicle width of the moving body 1 found based on the moving body information to the width on the screen based on the path information, the camera specification, as well as the position and direction of the moving body 1 at the image photographing time, for example. In other words, the left and right ends of the displayed band may be obtained by subjecting the paths of the left and right ends of the moving body 1 to the coordinate conversion based on the above method when the moving body 1 travels along the autonomous traveling path.

The embodiment of the present invention is not limited to a particular type with regard to the display example of the superposed information.

In addition to the autonomous traveling path, information for providing easier remote control may also be further superposed on the image.

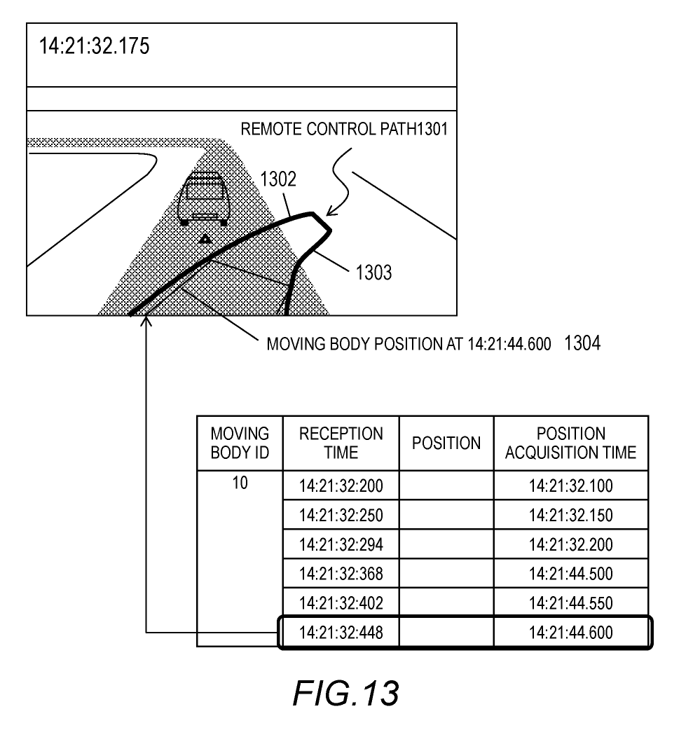

FIG. 13 is a schematic view illustrating a specific example of the information superposed on the screen in the embodiment of the present invention.

A remote control path 1301 of FIG. 13 shows a path along which the moving body 1 travels based on the operation of the controller 32 by the operator. For example, when the operator operates the controller 32 so that the moving body 1 is turned in a rightward direction, the remote control path display program 376 may predict the remote control path 1301 including the traveling path 1302 that would be drawn by the left end of the turned moving body 1 and the traveling path 1303 that would be drawn by the right end based on the position and direction of the moving body 1 at the photographing time T and the input value of the controller 32, for example. In this case, the distance between the left end and the right end is identified based on the vehicle width of the moving body 1 included in the moving body information. Then, the remote control path display program 376 may subject the calculated remote control path 1301 to the coordinate conversion based on the camera specification, for example as in the autonomous traveling path to superpose the remote control path 1301 subjected to the coordinate conversion on the image of the imaging time T to output the resultant image to the display 31 (S211). When the position information of the moving body 1 after the imaging time T of the screen is retained by the moving body information storage unit 34, the remote control path display program 376 may also similarly subject the future position of the moving body 1 after the imaging time T based on the position information to the coordinate conversion to superpose the resultant image on the image of the imaging time T to draw the resultant image. When the moving body information includes the information for the size and shape of the moving body 1, a graphic shape obtained by the conversion of the size and shape of the moving body 1 to the corresponding size and shape on the screen may also be drawn.

As has been already described, since the acquisition time of the position information is not synchronous with the imaging time of the image, when the operator watches the image displayed on the display 31, the actual moving body 1 may be ahead of the position at which the image was photographed. However, the display as shown in FIG. 13 allows the operator to more accurately know the positional relation between the moving body 1 and the autonomous traveling path and the influence by the operation of the controller 32 on the relation.

The operator existing in the remote support center 3 operates the controller 32 based on the information drawn on the display 31 of the remote support center 3. The control signal generation program 374 of the remote support center 3 generates, based on the input value of the controller 32, a control signal for controlling the moving body 1 to transmit the control signal to the moving body 1 (S212). The operation control program 174 of the moving body 1 operates the moving body 1 based on the received control signal (S108), thereby realizing the remote control.

The operator visually recognizes both the superposed autonomous traveling path and the image to thereby determine the destination to which the moving body should be allowed to travel by the remote control. When a collision-damaged vehicle exists on the autonomous traveling path as shown in FIG. 1A and FIG. 1B, for example, the autonomous traveling path is moved in the rightward direction to avoid the collision-damaged vehicle and move the moving body back onto the autonomous traveling path in front of the collision-damaged vehicle.

The driving state monitoring program 175 of the moving body 1 sequentially monitors whether or not the moving body 1 can restart the autonomous traveling (S109). The present invention assumes that it is determined that the moving body 1 can restart the autonomous traveling if the moving body 1 exists on the autonomous traveling path and has no object hindering its travel ahead on the autonomous traveling path (S003).

If the driving state monitoring program 175 of the moving body 1 determines that the moving body 1 can restart the autonomous traveling, the driving state monitoring program 175 notifies the remote support center 3 of the fact that the autonomous traveling can be restarted (S110). The remote support reception program 371 of the remote support center 3 accepts the fact that the moving body 1 can restart the autonomous traveling and stops the processing of the programs executed during the remote control (e.g., the processing to draw the display 31) (S213).

After the driving state monitoring program 175 determines that the moving body 1 can restart the autonomous traveling, the transmission image generation program 171 of the moving body 1 stops the image transmission. The moving body 1 restarts the autonomous traveling (S111).

According to the processing as described above, with regard to the image transmitted from the moving body 1, the remote support center 3 estimates the position and direction of the moving body 1 at the photographing time of the image. Based on the result thereof, the autonomous traveling path of the moving body 1 is superposed on the image to thereby correctly display a region as a destination of the remote control. Thus, the operator performing the remote control can move the moving body easily. When it is determined that the moving body 1 can no longer continue the autonomous traveling and the moving body 1 is subjected to the remote control, the position of the moving body 1 at the transmission of the image and the photographing time of the image is estimated, for example, to thereby prevent the occurrence of unnecessary communication and calculation.

The present invention is not limited to the above-described embodiments and includes various modification examples. For example, the above embodiments are detailed descriptions intended to provide a deeper understanding of the present invention and are not limited to those that include all of the configurations in the description.

Furthermore, any of the above configurations, functions, processing units, processing means, and the like may be partially or entirely realized by hardware by designing them using an integrated circuit, for example. The above respective configurations, functions, and the like may also be realized by software by allowing a processor to interpret and execute a program realizing each function. Information for a program, table, or file for realizing each function can be stored in a storage device such as a non-volatile semiconductor memory, a hard disk drive, or SSD (Solid State Drive) or in a computer-readable non-temporal data storage medium such as an IC card, SD card, or DVD.

The shown control line and information line are what is considered to be required for a description purpose and do not always represent all control lines and information lines. Virtually all configurations may be considered as being connected to one another.

What is claimed is:

1. A moving body remote control system having a processor, an interface unit that is coupled to the processor and that communicates with the moving body, a storage unit coupled to the processor, and a display unit coupled to the processor, wherein:
the storage unit retains path information showing the position of a path along which the moving body autonomously travels and camera information including the position, direction, and angle of view of a camera provided in the moving body; and
the processor is configured:
to store, upon receiving the position of the moving body and the acquisition time of the position via the interface unit, the received position and acquisition time in the storage unit;
to output, upon receiving an image taken by the camera and an imaging time at which the image was taken via the interface unit, data of the received image to the display unit and store the imaging time in the storage unit;
to estimate, based on the imaging time and the position of the moving body at the acquisition time, the position and direction of the moving body at the imaging time;
to identify a part of the path included in the range of the image based on the path information, the camera information, and the estimated position and direction of the moving body; and
to convert, based on the path information, the camera information, and the estimated position and direction of the moving body, the coordinates of the identified part of the path into coordinates of the image and output, to the display unit, data of the image on which the path is superposed, at the position of the converted coordinates.

2. The moving body remote control system according to claim 1, wherein:
the moving body remote control system further has a controller that is coupled to the processor and that receives an input of the operation of the moving body; and
when the moving body determines that the moving body can no longer continue the autonomous travel on the path, the moving body transmits a remote control request to the moving body remote control system,
the processor being configured:
to estimate, upon receiving the remote control request from the moving body via the interface unit, the position and direction of the moving body at the imaging time, to identify a part of the path included in the range of the image, to output data of the image on which the path is superposed; and
to transmit, after receiving the remote control request, a control signal depending on the operation inputted to the controller to the moving body via the interface unit.

3. The moving body remote control system according to claim 1, wherein
the processor converts, when the position of the moving body acquired at a time later than the imaging time is retained by the storage unit, the coordinates of the position of the moving body acquired at the time later than the imaging time into coordinates on the image and outputs, to the display unit, data of the image on which the moving body is superposed, at the position of the converted coordinates.

4. The moving body remote control system according to claim 1, wherein:
the storage unit retains information showing the width of the moving body; and
the processor converts, based on the path information and the camera information, the width of the moving body into the corresponding width on the image to superpose a graphic shape having the converted width on the image as the path.

5. The moving body remote control system according to claim 1, wherein
the processor is configured:
to estimate, based on the position of the moving body at the acquisition time, the direction of the moving body at the acquisition time;
to estimate the position of the moving body at the imaging time by multiplying a difference between the position of the moving body acquired at a first time earlier than the imaging time and the position of the moving body acquired at a second time later than the imaging time with a ratio of the length from the first time to the photographing time of the image to the length from the first time to the second time to add the resultant value to the position of the moving body acquired at the first time; and
to estimate the direction of the moving body at the imaging time by multiplying a difference between the direction of the moving body at the first time and the direction of the moving body at the second time with the ratio of the length from the first time to the imaging time to the length from the first time to the second time to add the resultant value to the direction of the moving body acquired at the first time.

6. The moving body remote control system according to claim 1, wherein
the processor is configured:
to estimate the direction of the moving body at the acquisition time based on the position of the moving body at the acquisition time; and
to estimate the position of the moving body acquired at a time closest to the imaging time and the direction of the moving body at the acquisition time as the direction of the moving body at the imaging time.

7. The moving body remote control system according to claim 1, wherein
the moving body remote control system further has a controller that is coupled to the processor and that receives an input of the control of the moving body,
the processor being configured:
to predict, when the controller receives an input of the operation to the moving body, a path of the moving body controlled in accordance with the inputted operation based on the estimated position and direction of the moving body and the inputted operation,
to convert the predicted path to coordinates on the image,
to output, to the display unit, data of the image on which the predicted path is superposed, at the position of the converted coordinates on the image, and
to transmit a control signal depending on the inputted operation to the moving body via the interface unit.

8. A moving body remote control method using a moving body remote control system having a processor, an interface unit that is coupled to the processor and that communicates with a moving body, a storage unit coupled to the processor, and a display unit coupled to the processor, wherein
the storage unit retains path information showing the position of a path along which the moving body autonomously travels and camera information including the position, direction, and angle of view of a camera provided in the moving body,
the moving body remote control method including:
a step of storing, by the processor, upon receiving the position of the moving body and the acquisition time of the position via the interface unit, the received position and acquisition time in the storage unit;
a step of outputting, by the processor, upon receiving an image taken by the camera and an imaging time at which the image was taken via the interface unit, data of the received image to the display unit and store the imaging time in the storage unit;
a step of estimating, by the processor, the position and direction of the moving body at the imaging time based on the imaging time and the position of the moving body at the acquisition time;
a step of identifying, by the processor, a part of the path included in the range of the image based on the path information, the camera information, and the estimated position and direction of the moving body; and
a step of converting, by the processor, the coordinates of the identified part of the path into coordinates on the image based on the path information, the camera information, and the estimated position and direction of the moving body to output, to the display unit, data of the image on which the path is superposed, at the position of the converted coordinates.
